(19) United States
(12) Patent Application Publication
(10) Pub. No.: US 2016/0147093 A1
(43) Pub. Date: May 26, 2016

(54) DISPLAY PANEL AND DISPLAY DEVICE

(71) Applicant: Shenzhen China Star Optoelectronics Technology Co., Ltd., Shenzhen (CN)

(72) Inventors: Xinhui Zhong, Shenzhen (CN); Yung-Jui Lee, Shenzhen (CN)

(73) Assignee: Shenzhen China Star Optoelectronics Technology Co., Ltd., Shenzhen (CN)

(21) Appl. No.: 14/416,083

(22) PCT Filed: Nov. 28, 2014
(86) PCT No.: PCT/CN2014/092572

§ 371 Date: Jan. 21, 2015

(30) Foreign Application Priority Data
Nov. 21, 2014 (CN) 201410674480.X

(51) Int. Cl. G02F 1/1337; G02F 1/1335; G02F 1/1343; G02F 1/1368

(52) U.S. Cl. CPC G02F 1/1337; G02F 1/1368; G02F 1/133514; G02F 1/134309

(57) ABSTRACT

A display panel and a display device are disclosed. The display panel includes a color filter substrate, a liquid crystal layer, and a thin film transistor array substrate. The color filter substrate includes a first protecting layer and a common electrode layer disposed thereon. The thin film transistor array substrate includes a second protecting layer and a pixel electrode disposed thereon. The common electrode layer is disposed corresponding to the pixel electrode. The liquid crystal layer includes one or more liquid crystal molecules, one or more first auxiliary alignment agent molecules, and one or more second auxiliary alignment agent molecules. The present invention can decrease occurrences of dark areas.

### BACKGROUND OF THE INVENTION

1. Field of the Invention

The present invention generally relates to a display technical field, and more particularly to a display panel and a display device.

2. Description of Prior Art

In the prior art, a vertical alignment process is usually performed to liquid crystal molecules, such that the liquid crystal molecules of a vertical alignment (VA) liquid crystal display (LCD) device are arranged perpendicularly to a surface of a substrate.

Currently, a commonly used method is to coat an alignment agent on predetermined areas of an upper substrate and a lower substrate. The alignment agent usually comprises numerous chemical solvents, for example, N-Methyl-2-pyrrolidone (NMP) and polymer material such as polyimide (PI). Then, the substrates are baked at a high temperature (usually higher than 200° C.) for a long time, thereby drying the solvents in the alignment agent are dried and forming PI alignment layers on the surfaces of the glass substrates.

Since the above-mentioned alignment agent comprises numerous NMP solvents, the manufacturing process for forming the alignment layers is high energy consumption, unfriendly to the environment, and easily harmful to a human body. Furthermore, the product yield rate is decreased due to the problems of homogeneity, adsorption, and particles of the alignment layers, and thus the resources are wasted and the production cost is high.

Nowadays, a technical scheme for improving the above-mentioned deficiencies is as follows. Auxiliary alignment agents 2022 and 223 are added to liquid crystal molecules 2021, such that the liquid crystal molecules 2021 can be arranged perpendicularly to a surface of a substrate of a liquid crystal display device in the situation that an alignment layer does not exists. It is not necessary to dissolve the auxiliary alignment agents 2022 and 2023 in a solvent. The auxiliary alignment agents 2022 and 2023 are directly dissolved in the liquid crystal layer and used together with liquid crystal molecules 2021. Accordingly, the coating device and the high-temperature baking device for the original alignment agent are not used. Since an extra solvent is not necessary, the auxiliary alignment agents 2022 and 2023 are clear, environmental friendly, and energy saving.

The action principle of the auxiliary alignment agents 2022 and 2023 is that an end of a molecule has a special affinity with an inorganic material, such as indium tin oxide (ITO) 104 and SiNx (silicon nitride) 2012, for adsorbing to the surface of the substrate, and the other end of the molecule has a strong action force to a liquid crystal molecule 2021. As a result, the liquid crystal molecules 2021 are guided to be arranged perpendicularly to the surface of the substrate, as shown in FIG. 2.

As shown in FIG. 1 and FIG. 2, a part of a pixel electrode area is covered by the ITO 104, and a part of the pixel electrode area is not covered by the ITO 104. In the situation that a PI alignment layer is not used and the alignment is achieved by using the auxiliary alignment agents 2022 and 2023 for adsorbing to the surface of the substrate, the alignment is poor. This is because the surface of the substrate comprises the ITO 104 and SiNx 2012 disposed thereon. Accordingly, the action forces of the auxiliary alignment agents 2022 and 2023 and the surface of the substrate are different, and the alignment is poor. When voltages are applied, dark line defects and bright line defects easily occur, and the display effect is shown in FIG. 3.

Consequently, there is a need to provide a new technical scheme for solving the above-mentioned problems in the prior art.

### SUMMARY OF THE INVENTION

An objective of the present invention is to provide a display panel and a display device which can eliminate differences of adsorbing forces of auxiliary alignment agent molecules in different positions on a pixel area, thereby decreasing occurrences of dark areas.

To solve the above-mentioned problems, a technical scheme of the present invention is described as follows. A display panel comprises a color filter substrate, a thin film transistor array substrate, and a liquid crystal layer. The color filter substrate comprises a first protecting layer and a common electrode layer disposed thereon. The common electrode layer is disposed on the first protecting layer. The thin film transistor array substrate comprises a second protecting layer and a pixel electrode disposed thereon. The pixel electrode is disposed on the second protecting layer. The common electrode layer is disposed corresponding to the pixel electrode. The liquid crystal layer comprises one or more liquid crystal molecules, one or more first auxiliary alignment agent molecules, and one or more second auxiliary alignment agent molecules. A first end of each of the first auxiliary alignment agent molecules is used for adsorbing to a surface of the common electrode layer, and a second end of each of the first auxiliary alignment agent molecules is used for guiding an arrangement of a corresponding one of liquid crystal molecules. A third end of each of the second auxiliary alignment agent molecules is used for adsorbing to a surface of the pixel electrode and a surface of the second protecting layer, and a fourth end of each of the second auxiliary alignment agent molecules is used for guiding an arrangement of a corresponding one of the liquid crystal molecule. The color filter substrate is aligned with and assembled to the thin film transistor array substrate, and the liquid crystal layer is disposed between the color filter substrate and the thin film transistor array substrate. The pixel electrode is disposed to be an uneven curved surface. A whole surface of the pixel electrode covers the second protecting layer corresponding to a pixel area. The pixel electrode is used for applying an electric field to the liquid crystal molecules and used for separating the second auxiliary alignment agent molecules from the second protecting layer. The surface of the pixel electrode is disposed to be a wave shape.

In the display panel, the pixel electrode comprises one or more first concave areas and one or more convex areas. The pixel electrode is further used for making the second auxiliary alignment agent molecules be adsorbed to surfaces of the first concave areas and surfaces of the first convex areas. An inclined surface is disposed between one of the first concave areas and one of the first convex areas, and the inclined surface connects the one of the first concave areas to the one of the first convex areas. The pixel electrode is further used for controlling the second auxiliary alignment agent molecules along the inclined surface to be inclined in a predetermined direction. The thin film transistor array substrate further comprises a shape forming layer. A surface of the shape forming layer is disposed to be an uneven shape. The pixel electrode is disposed on the shape forming layer, and the shape forming layer is used for forming an uneven degree of the surface of the pixel electrode.

A display panel comprises a color filter substrate, a thin film transistor array substrate, and a liquid crystal layer. The color filter substrate comprises a first protecting layer and a common electrode layer disposed thereon. The common electrode layer is disposed on the first protecting layer. The thin film transistor array substrate comprises a second protecting layer and a pixel electrode disposed thereon. The pixel electrode is disposed on the second protecting layer. The common electrode layer is disposed corresponding to the pixel electrode. The liquid crystal layer comprises one or more liquid crystal molecules, one or more first auxiliary alignment agent molecules, and one or more second auxiliary alignment agent molecules. A first end of each of the first auxiliary alignment agent molecules is used for adsorbing to a surface of the common electrode layer, and a second end of each of the first auxiliary alignment agent molecules is used for guiding an arrangement of a corresponding one of liquid crystal molecules. A third end of each of the second auxiliary alignment agent molecules is used for adsorbing to a surface of the pixel electrode and a surface of the second protecting layer, and a fourth end of each of the second auxiliary alignment agent molecules is used for guiding an arrangement of a corresponding one of the liquid crystal molecule. The color filter substrate is aligned with and assembled to the thin film transistor array substrate, and the liquid crystal layer is disposed between the color filter substrate and the thin film transistor array substrate.

In the display panel, the pixel electrode is disposed to be an uneven curved surface. A whole surface of the pixel electrode covers the second protecting layer corresponding to a pixel area. The pixel electrode is used for applying an electric field to the liquid crystal molecules and used for separating the second auxiliary alignment agent molecules from the second protecting layer.

In the display panel, the pixel electrode comprises one or more first concave areas and one or more convex areas. The pixel electrode is further used for making the second auxiliary alignment agent molecules be adsorbed to surfaces of the first concave areas and surfaces of the first convex areas.

In the display panel, an inclined surface is disposed between one of the first concave areas and one of the first convex areas, and the inclined surface connects the one of the first concave areas to the one of the first convex areas. The pixel electrode is further used for controlling the second auxiliary alignment agent molecules along the inclined surface to be inclined in a predetermined direction.

In the display panel, each of the first concave areas of the pixel electrode comprises one or more concave grooves disposed thereon, and each of the first convex areas of the pixel electrode comprises one or more convex ribs disposed thereon. The convex ribs and the concave grooves are disposed in parallel. At least two of the convex ribs are arranged in an array in a first direction, and at least two of the concave grooves are arranged in an array in the first direction. One of the concave grooves is disposed between two adjacent convex ribs of the convex ribs, and one of the convex ribs is disposed between two adjacent concave grooves of the concave grooves.

In the display panel, the thin film transistor array substrate further comprises a shape forming layer. A surface of the shape forming layer is disposed to be an uneven shape. The pixel electrode is disposed on the shape forming layer, and the shape forming layer is used for forming an uneven degree of the surface of the pixel electrode.

In the display panel, the shape forming layer comprises one or more second concave areas and one or more second convex areas. Positions of the second concave areas correspond to positions of the first concave areas, and positions of the second convex areas correspond to positions of the first convex areas. The shape forming layer is formed on the pixel area, and the shape forming layer is disposed between the pixel electrode and the second protecting layer. The shape forming layer is formed before the step of forming the pixel electrode by coating an organic transparent photoresist on the second protecting layer and then performing an exposure process, a development process, and a baking process to the organic transparent photoresist, such that a surface of the organic transparent photoresist is disposed to be an uneven shape.

In the display panel, the second protecting layer serves as the shape forming layer, and the shape forming layer is formed before the step of forming the pixel electrode by performing an exposure process, a development process, and a baking process to the second protecting layer, such that the surface of the second protecting layer is disposed to be an uneven surface.

In the display panel, the first auxiliary alignment agent molecules and the second auxiliary alignment agent molecules are respectively used for making the liquid crystal molecules be arranged perpendicularly to a surface of the color filter substrate and a surface of the thin film transistor array substrate in the situation that an alignment layer is not used.

A display device comprises a backlight module and a display panel. The display panel is aligned with and assembled to the backlight module. The display panel comprises a color filter substrate, a thin film transistor array substrate, and a liquid crystal layer. The color filter substrate comprises a first protecting layer and a common electrode layer disposed thereon. The common electrode layer is disposed on the first protecting layer. The thin film transistor array substrate comprises a second protecting layer and a pixel electrode disposed thereon. The pixel electrode is disposed on the second protecting layer. The common electrode layer is disposed corresponding to the pixel electrode. The liquid crystal layer comprises one or more liquid crystal molecules, one or more first auxiliary alignment agent molecules, and one or more second auxiliary alignment agent molecules. A first end of each of the first auxiliary alignment agent molecules is used for adsorbing to a surface of the common electrode layer, and a second end of each of the first auxiliary alignment agent molecules is used for guiding an arrangement of a corresponding one of liquid crystal molecules. A third end of each of the second auxiliary alignment agent molecules is used for adsorbing to a surface of the pixel electrode and a surface of the second protecting layer, and a fourth end of each of the second auxiliary alignment agent molecules is used for guiding an arrangement of a corresponding one of the liquid crystal molecule. The color filter substrate is aligned with and assembled to the thin film transistor array substrate, and the liquid crystal layer is disposed between the color filter substrate and the thin film transistor array substrate.

In the display device, the pixel electrode is disposed to be an uneven curved surface. A whole surface of the pixel electrode covers the second protecting layer corresponding to a pixel area, and the pixel electrode is used for applying an electric field to the liquid crystal molecules and used for separating the second auxiliary alignment agent molecules from the second protecting layer.

In the display device, the pixel electrode comprises one or more first concave areas and one or more convex areas. The pixel electrode is further used for making the second auxiliary alignment agent molecules be adsorbed to surfaces of the first concave areas and surfaces of the first convex areas.

In the display device, an inclined surface is disposed between one of the first concave areas and one of the first convex areas, and the inclined surface connects the one of the first concave areas to the one of the first convex areas. The pixel electrode is further used for controlling the second auxiliary alignment agent molecules along the inclined surface to be inclined in a predetermined direction.

In the display device, each of the first concave areas of the pixel electrode comprises one or more concave grooves disposed thereon, and each of the first convex areas of the pixel electrode comprises one or more convex ribs disposed thereon. The convex ribs and the concave grooves are disposed in parallel. At least two of the convex ribs are arranged in an array in a first direction, and at least two of the concave grooves are arranged in an array in the first direction. One of the concave grooves is disposed between two adjacent convex ribs of the convex ribs, and one of the convex ribs is disposed between two adjacent concave grooves of the concave grooves.

In the display device, the thin film transistor array substrate further comprises a shape forming layer. A surface of the shape forming layer is disposed to be an uneven shape. The pixel electrode is disposed on the shape forming layer, and the shape forming layer is used for forming an uneven degree of the surface of the pixel electrode.

In the display device, the shape forming layer comprises one or more second concave areas and one or more second convex areas. Positions of the second concave areas correspond to positions of the first concave areas, and positions of the second convex areas correspond to positions of the first convex areas. The shape forming layer is formed on the pixel area, and the shape forming layer is disposed between the pixel electrode and the second protecting layer. The shape forming layer is formed before the step of forming the pixel electrode by coating an organic transparent photoresist on the second protecting layer and then performing an exposure process, a development process, and a baking process to the organic transparent photoresist, such that a surface of the organic transparent photoresist is disposed to be an uneven shape.

In the display device, the second protecting layer serves as the shape forming layer, and the shape forming layer is formed before the step of forming the pixel electrode by performing an exposure process, a development process, and a baking process to the second protecting layer, such that the surface of the second protecting layer is disposed to be an uneven surface.

In the display device, the first auxiliary alignment agent molecules and the second auxiliary alignment agent molecules are respectively used for making the liquid crystal molecules be arranged perpendicularly to a surface of the color filter substrate and a surface of the thin film transistor array substrate in the situation that an alignment layer is not used.

Comparing with prior art, the present invention can make the second auxiliary alignment agent molecules be only adsorbed to the pixel electrode on the pixel area. As a result, the differences of the adsorbing forces of the second auxiliary alignment agent molecules in different positions on the pixel area can be eliminated, thereby decreasing the occurrences of dark areas.

For a better understanding of the aforementioned content of the present invention, preferable embodiments are illustrated in accordance with the attached figures for further explanation.

### BRIEF DESCRIPTION OF THE DRAWINGS

FIG. 1 shows a partial schematic of a display panel in the prior art;

FIG. 2 shows a cross sectional schematic along A-A′ in FIG. 1;

FIG. 3 shows that occurrences of dark areas in the display panel in the prior art;

FIG. 4 shows a partial schematic of a display panel in accordance with the present invention;

FIG. 5 shows a cross sectional schematic along B-B′ in FIG. 4 in accordance with a first embodiment;

FIG. 6 shows an isometric axonometric view in which the shape forming layer is combined with the pixel electrode in accordance with the display panel of the present invention;

FIG. 7 shows an exploded view of the shape forming layer and the pixel electrode in FIG. 6; and

FIG. 8 shows a cross sectional schematic along B-B′ in FIG. 4 in accordance with a second embodiment.

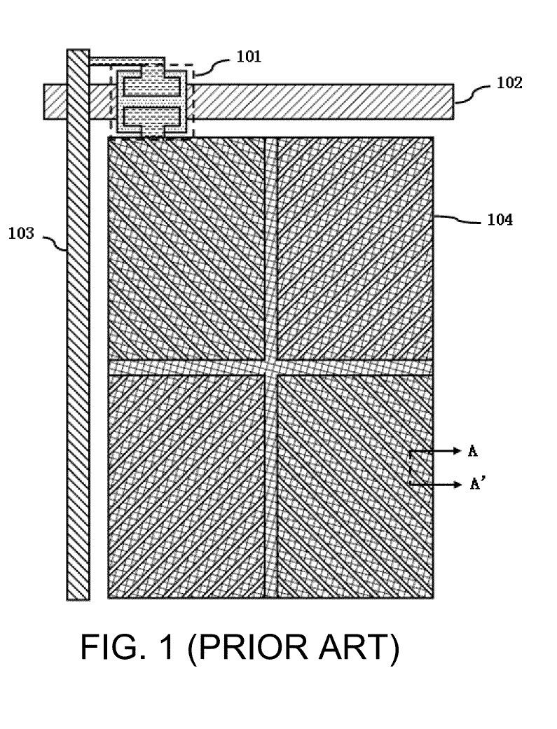

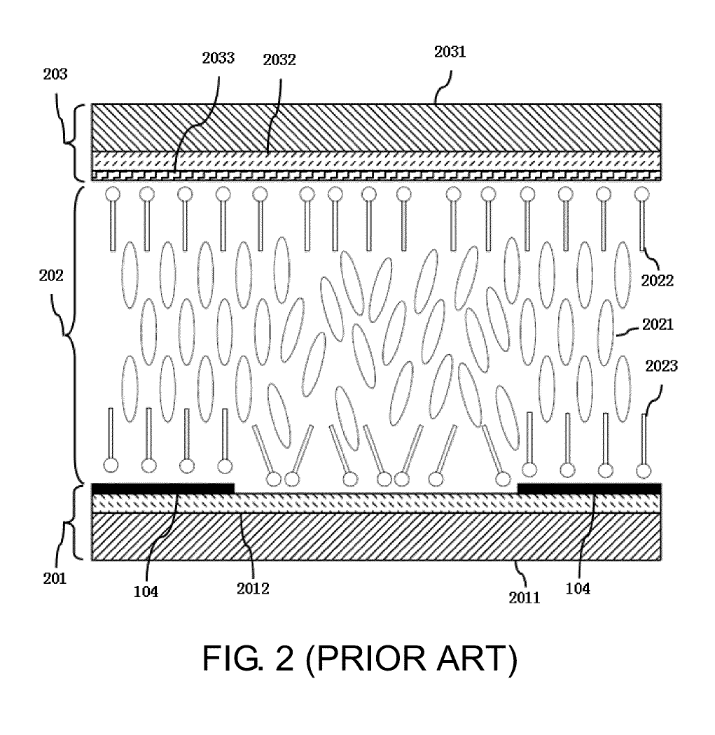

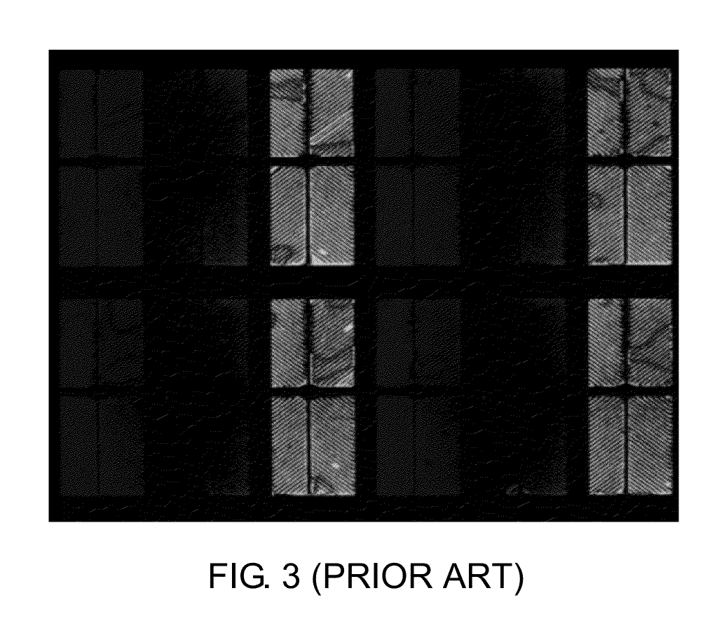

### DETAILED DESCRIPTION OF THE INVENTION

The term “embodiment” in the specification refers to an implementation or an example of one or more of the inventions. Furthermore, as used in the description herein and throughout the claims that follow, the meaning of “a” includes plural reference unless the context clearly dictates otherwise.

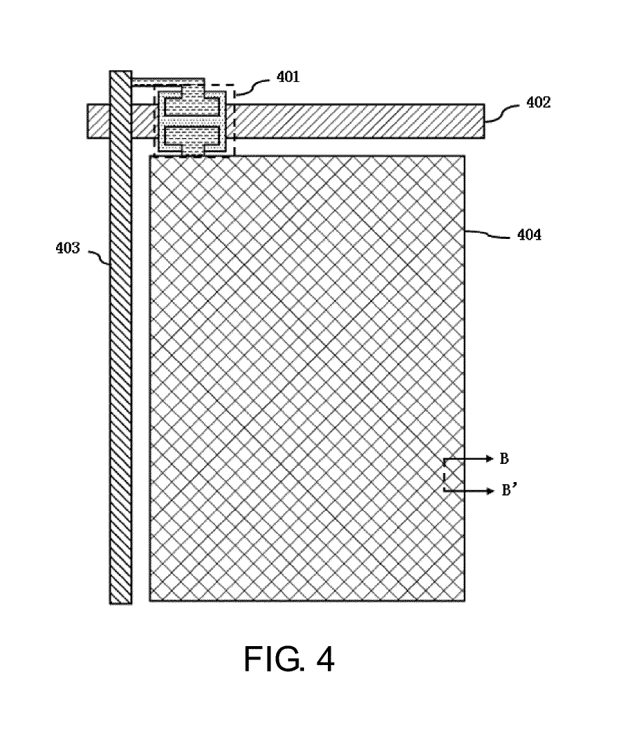

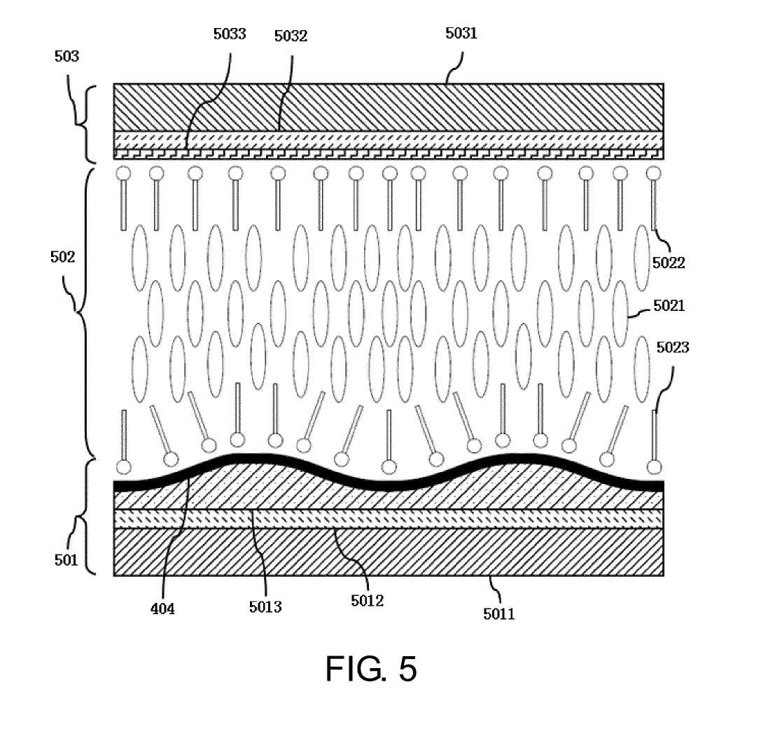

Please refer to FIG. 4 and FIG. 5. FIG. 4 shows a partial schematic of a display panel in accordance with the present invention. FIG. 5 shows a cross sectional schematic along B-B′ in FIG. 4 in accordance with a first embodiment.

In the present embodiment, a liquid crystal display device comprises a backlight module and the display panel. The display panel is aligned with and assembled to the backlight module. The display panel comprises a color filter substrate 503, a thin film transistor array substrate 501, and a liquid crystal layer 502. The color filter substrate 503 is aligned with and assembled to the thin film transistor array substrate 501. The liquid crystal layer 502 is disposed between the color filter substrate 503 and the thin film transistor array substrate 501.

The color filter substrate 503 comprises a first protecting layer 5032 and a common electrode layer 5033. The common electrode layer 5033 is disposed on the first protecting layer 5032. The thin film transistor array substrate 501 comprises a second protecting layer 5012 and a pixel electrode 404. The common electrode layer 5033 is disposed corresponding to the pixel electrode 404. That is, the common electrode layer 5033 is disposed on a surface of the color filter substrate 503 facing the liquid crystal layer 502, and the pixel electrode 404 is disposed on a surface of the thin film transistor array substrate 501 facing the liquid crystal layer 502.

The liquid crystal layer 502 comprises one or more liquid crystal molecules 5021, one or more first auxiliary alignment agent molecules 5022, and one or more second auxiliary alignment agent molecules 5023. The first auxiliary alignment agent molecules 5022 and the second auxiliary alignment agent molecules 5023 are respectively used for making the liquid crystal molecules 5021 be arranged perpendicularly to the surface of the color filter substrate 503 and the surface of thin film transistor array substrate 501 in the situation that an alignment layer is not used. Specifically, an end of each of the first auxiliary alignment agent molecules 5022 and an end of each of the second auxiliary alignment agent molecules 5023 are respectively used for adsorbing to the surface of the color filter substrate 503 and the surface of the thin film transistor array substrate 501. The other end of each of the first auxiliary alignment agent molecules 5022 and the other end of each of the second auxiliary alignment agent molecules 5023 are respectively used for making the liquid crystal molecules 5021 be arranged in a direction perpendicular to the surface of the color filter substrate 503 and the surface of the thin film transistor array substrate 501. The first auxiliary alignment agent molecules 5022 and the second auxiliary alignment agent molecules 5023 are directly dissolved in the liquid crystal layer 502. The first auxiliary alignment agent molecules 5022 and the second auxiliary alignment agent molecules 5023 are injected into a liquid crystal cell together with the liquid crystal molecules 5021. A first end of each of the first auxiliary alignment agent molecules 5022 is used for adsorbing to the surface of the common electrode layer 5033, and a second end of each of the first auxiliary alignment agent molecules 5022 is used for guiding the arrangement of the corresponding liquid crystal molecule 5021. A third end of each of the second auxiliary alignment agent molecules 5023 is used for adsorbing to the pixel electrode 404 and the surface of the second protecting layer 5012, and a fourth end of each of the second auxiliary alignment agent molecules 5023 is used for guiding the arrangement of the corresponding liquid crystal molecule 5021.

The auxiliary alignment agent molecules including the first auxiliary alignment agent molecules 5022 and the second auxiliary alignment agent molecules 5023 have a molecular mass ranged from 100 to 800. The auxiliary alignment agent molecules comprise a polar group and a non-polar group. The polar group comprises a group selected from a group consisting of an oxygen atom, a nitrogen atom, and a sulfur atom. The non-polar group comprises a carbon chain structure of six-membered carboatomic ring. A main chain or a side chain of the carbon chain structure may comprise a substituent, such as oxygen and carbon. For example, the non-polar group comprises but is not limited to the following structure:

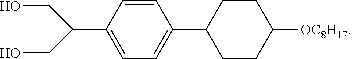

The color filter substrate 503 further comprises a first substrate 5031, a color photoresist array layer (not shown), and a black matrix layer (not shown). The photoresist array layer is disposed on the first substrate 5031, and the black matrix layer is disposed on the first substrate 5031. The first protecting layer 5032 is disposed on the color photoresist array layer and the black matrix layer. The common electrode layer 5033 is disposed on the first protecting layer 5032.

The thin film transistor array substrate 501 comprises a second substrate 5011 and an electrode array layer. The electrode array layer is disposed on the second substrate 5011. The electrode array layer comprises an electrode unit array, a data line array, a scan line array, and a thin film transistor switch array.

The scan line array comprises one or more scan lines 402, and the data line array comprises one or more data lines 403. The thin film transistor switch array comprises one or more thin film transistor switches 401. The pixel unit array comprises one or more pixel electrodes 404.

In the present embodiment, the pixel electrode 404 is disposed to be an uneven curved surface. A whole surface of the pixel electrode 404 covers a pixel area corresponding to the second protecting layer 5012. The pixel electrode 404 is used for applying an electric field to the liquid crystal molecules 5021 and used for separating the second auxiliary alignment agent molecules 5023 from the second protecting layer 5012. For example, the surface of the pixel electrode 404 may be disposed to be a wave shape.

In the present embodiment, the pixel electrode 404 comprises one or more first concave areas and one or more first convex areas.

The pixel electrode 404 is further used for making the second auxiliary alignment agent molecules 5023 be adsorbed to surfaces of the first concave areas and surfaces of the first convex areas of the pixel electrode 404.

In the present embodiment, an inclined surface is disposed between one of the first concave areas and one of the first convex areas. The inclined surface connects the one of the first concave areas to the one of the first convex areas.

The pixel electrode 404 is further used for controlling the second auxiliary alignment agent molecules 5023 along the inclined surface to be inclined in a predetermined direction.

Specifically, each of the first concave areas of the pixel electrode 404 comprises one or more concave grooves disposed thereon, and each of the first convex areas of the pixel electrode 404 comprises one or more convex ribs disposed thereon. The convex ribs and the concave grooves are disposed in parallel. At least two of the convex ribs are arranged in an array in a first direction, and at least two of the concave grooves are arranged in an array in the first direction. One of the concave grooves is disposed between two adjacent convex ribs of the convex ribs, and one of the convex ribs is disposed between two adjacent concave grooves of the concave grooves.

The pixel electrode 404 is divided into four domains including a first domain 4041, a second domain 4042, a third domain 4043, and a fourth domain 4044. Array directions of the convex ribs and array directions of the concave grooves on two adjacent domains are different. It is beneficial that the convex ribs and the concave grooves intersect on the two adjacent domains, such that the display panel can implement multi-domain wide angle effect. The convex ribs on the two adjacent domains are closely connected (seamlessly connected). The concave grooves on the two adjacent domains are closely connected (seamlessly connected).

In the present embodiment, the thin film transistor array substrate 501 further comprises a shape forming layer 5013.

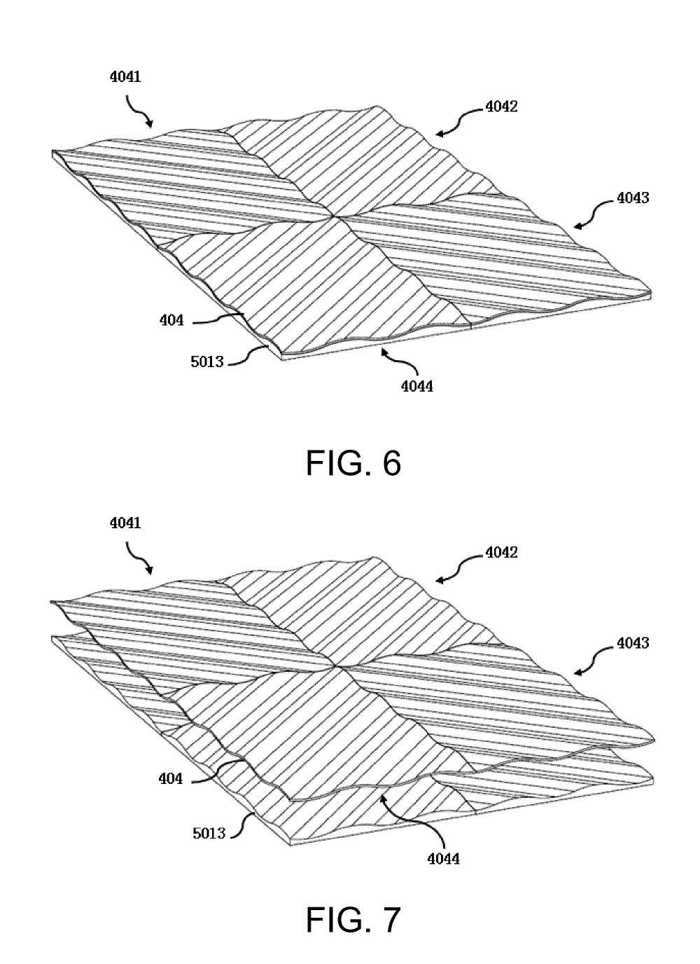

Please refer to FIG. 6 and FIG. 7. FIG. 6 shows an isometric axonometric view in which the shape forming layer 5013 is combined with the pixel electrode 404 in accordance with the display panel of the present invention. FIG. 7 shows an exploded view of the shape forming layer 5013 and the pixel electrode 404 in FIG. 6.

A surface of the shape forming layer 5013 is disposed to be an uneven shape. The pixel electrode 404 is disposed on the shape forming layer 5013. The shape forming layer 5013 is used for forming an uneven degree of the surface of the pixel electrode 404.

The shape forming layer 4013 comprises one or more second concave areas and one or more second convex areas. Positions of the second concave areas correspond to positions of the first concave areas, and positions of the second convex areas correspond to positions of the first convex areas. The shape forming layer 5013 is disposed on the pixel area. The shape forming layer 5013 is disposed between the pixel electrode 404 and the second protecting layer 5012. The shape forming layer 5013 is formed before the step of forming the pixel electrode 404 by coating an organic transparent photoresist on the second protecting layer 5012 and then performing an exposure process, a development process, and a baking process to the organic transparent photoresist, such that a surface of the organic transparent photoresist is an uneven shape.

The pixel electrode 404 is formed by disposing transparent conductive material, such as ITO (indium tin oxide), on the shape forming layer 5013 and then performing an exposure process, a development process, and a baking process to the transparent conductive material, such that a surface of the transparent conductive material is disposed to be an uneven shape.

In the above-mentioned technical scheme, the vertical alignment of the liquid crystal molecules 5021 is implemented by using the auxiliary alignment agent molecules, and a polyimide (PI) alignment layer is not used for aligning the liquid crystal molecules 5021. Accordingly, a PI process and a high-temperature baking process can be eliminated, machines is not necessary to be used, corresponding losses can be avoided, and the problem that a yield rate of the display panel due to the poor PI is low may be avoided.

Furthermore, since the pixel electrode 404 has a surface shape instead of a strip shape and the whole surface of the pixel electrode 404 covers the second protecting layer 5012, the second auxiliary alignment agent molecules 5023 are only adsorbed to the pixel electrode 404 on the pixel area. The second auxiliary alignment agent molecules 5023 are not adsorbed to the second protecting layer 5012 or other material. As a result, the differences of the adsorbing forces of the second auxiliary alignment agent molecules 5023 in different positions (positions corresponding to the stripped electrodes and the positions corresponding to the second protecting layer 5012) on the pixel area can be eliminated, thereby decreasing the occurrences of dark areas.

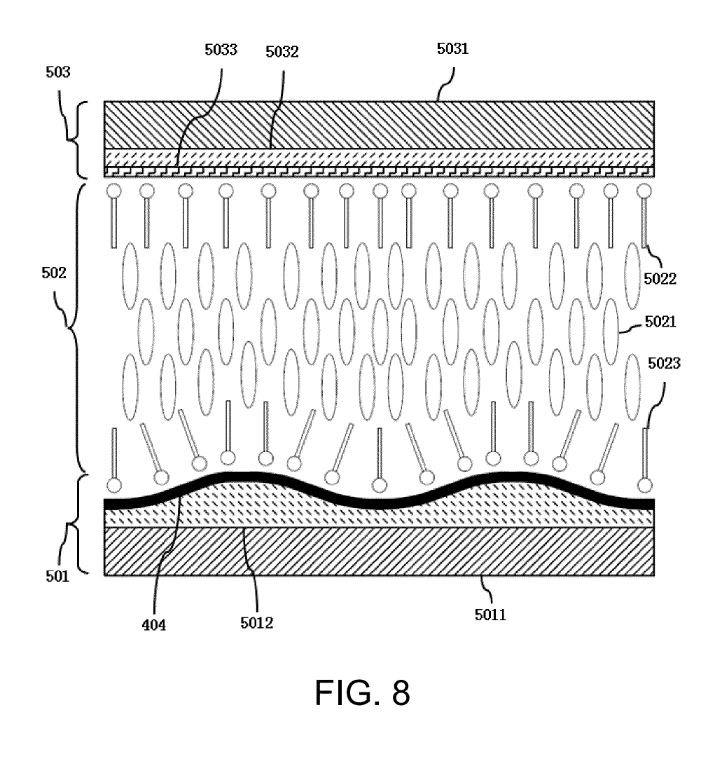

Please refer to FIG. 8. FIG. 8 shows a cross sectional schematic along B-B′ in FIG. 4 in accordance with a second embodiment. The present embodiment is similar to the above-mentioned first embodiment, and a difference is as follows.

In the present embodiment, the second protecting layer 5012 serves as the shape forming layer 5013. That is, the shape forming layer 5013 is formed before the step of forming the pixel electrode 404 by performing an exposure process, a development process, and a baking process to the second protecting layer 5012, such that a surface of the second protecting layer 2012 is disposed to be an uneven surface.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structures.

What is claimed is:

1. A display panel, comprising:
a color filter substrate, the color filter substrate comprising a first protecting layer and a common electrode layer disposed thereon, and the common electrode layer disposed on the first protecting layer;
a thin film transistor array substrate, the thin film transistor array substrate comprising a second protecting layer and a pixel electrode disposed thereon, and the pixel electrode disposed on the second protecting layer, wherein the common electrode layer is disposed corresponding to the pixel electrode; and
a liquid crystal layer comprising:
one or more liquid crystal molecules;
one or more first auxiliary alignment agent molecules, wherein a first end of each of the first auxiliary alignment agent molecules is used for adsorbing to a surface of the common electrode layer, and a second end of each of the first auxiliary alignment agent molecules is used for guiding an arrangement of a corresponding one of liquid crystal molecules; and
one or more second auxiliary alignment agent molecules, wherein a third end of each of the second auxiliary alignment agent molecules is used for adsorbing to a surface of the pixel electrode and a surface of the second protecting layer, and a fourth end of each of the second auxiliary alignment agent molecules is used for guiding an arrangement of a corresponding one of the liquid crystal molecule;
wherein the color filter substrate is aligned with and assembled to the thin film transistor array substrate, and the liquid crystal layer is disposed between the color filter substrate and the thin film transistor array substrate;
the pixel electrode is disposed to be an uneven curved surface, a whole surface of the pixel electrode covers the second protecting layer corresponding to a pixel area, and the pixel electrode is used for applying an electric field to the liquid crystal molecules and used for separating the second auxiliary alignment agent molecules from the second protecting layer;
the surface of the pixel electrode is disposed to be a wave shape.

2. The display panel of claim 1, wherein the pixel electrode comprises one or more first concave areas and one or more convex areas;
the pixel electrode is further used for making the second auxiliary alignment agent molecules be adsorbed to surfaces of the first concave areas and surfaces of the first convex areas;
an inclined surface is disposed between one of the first concave areas and one of the first convex areas, and the inclined surface connects the one of the first concave areas to the one of the first convex areas;
the pixel electrode is further used for controlling the second auxiliary alignment agent molecules along the inclined surface to be inclined in a predetermined direction;
the thin film transistor array substrate further comprises a shape forming layer, a surface of the shape forming layer is disposed to be an uneven shape, the pixel electrode is disposed on the shape forming layer, and the shape forming layer is used for forming an uneven degree of the surface of the pixel electrode.

3. A display panel, comprising:
a color filter substrate, the color filter substrate comprising a first protecting layer and a common electrode layer disposed thereon, and the common electrode layer disposed on the first protecting layer;
a thin film transistor array substrate, the thin film transistor array substrate comprising a second protecting layer and a pixel electrode disposed thereon, and the pixel electrode disposed on the second protecting layer, wherein the common electrode layer is disposed corresponding to the pixel electrode; and
a liquid crystal layer comprising:
one or more liquid crystal molecules;
one or more first auxiliary alignment agent molecules, wherein a first end of each of the first auxiliary alignment agent molecules is used for adsorbing to a surface of the common electrode layer, and a second end of each of the first auxiliary alignment agent molecules is used for guiding an arrangement of a corresponding one of the liquid crystal molecules; and
one or more second auxiliary alignment agent molecules, wherein a third end of each of the second auxiliary alignment agent molecules is used for adsorbing to a surface of the pixel electrode and a surface of the second protecting layer, and a fourth end of each of the second auxiliary alignment agent molecules is used for guiding an arrangement of a corresponding one of the liquid crystal molecules;
wherein the color filter substrate is aligned with and assembled to the thin film transistor array substrate, and the liquid crystal layer is disposed between the color filter substrate and the thin film transistor array substrate.

4. The display panel of claim 3, wherein the pixel electrode is disposed to be an uneven curved surface, a whole surface of the pixel electrode covers the second protecting layer corresponding to a pixel area, and the pixel electrode is used for applying an electric field to the liquid crystal molecules and used for separating the second auxiliary alignment agent molecules from the second protecting layer.

5. The display panel of claim 4, wherein the pixel electrode comprises one or more first concave areas and one or more convex areas;
the pixel electrode is further used for making the second auxiliary alignment agent molecules be adsorbed to surfaces of the first concave areas and surfaces of the first convex areas.

6. The display panel of claim 5, wherein an inclined surface is disposed between one of the first concave areas and one of the first convex areas, and the inclined surface connects the one of the first concave areas to the one of the first convex areas;
the pixel electrode is further used for controlling the second auxiliary alignment agent molecules along the inclined surface to be inclined in a predetermined direction.

7. The display panel of claim 5, wherein each of the first concave areas of the pixel electrode comprises one or more concave grooves disposed thereon, and each of the first convex areas of the pixel electrode comprises one or more convex ribs disposed thereon;
the convex ribs and the concave grooves are disposed in parallel, at least two of the convex ribs are arranged in an array in a first direction, and at least two of the concave grooves are arranged in an array in the first direction;
one of the concave grooves is disposed between two adjacent convex ribs of the convex ribs, and one of the convex ribs is disposed between two adjacent concave grooves of the concave grooves.

8. The display panel of claim 5, wherein the thin film transistor array substrate further comprises a shape forming layer, a surface of the shape forming layer is disposed to be an uneven shape, the pixel electrode is disposed on the shape forming layer, and the shape forming layer is used for forming an uneven degree of the surface of the pixel electrode.

9. The display panel of claim 8, wherein the shape forming layer comprises one or more second concave areas and one or more second convex areas, positions of the second concave areas correspond to positions of the first concave areas, and positions of the second convex areas correspond to positions of the first convex areas;
the shape forming layer is formed on the pixel area, and the shape forming layer is disposed between the pixel electrode and the second protecting layer;
the shape forming layer is formed before the step of forming the pixel electrode by coating an organic transparent photoresist on the second protecting layer and then performing an exposure process, a development process, and a baking process to the organic transparent photoresist, such that a surface of the organic transparent photoresist is disposed to be an uneven shape.

10. The display panel of claim 8, wherein the second protecting layer serves as the shape forming layer, and the shape forming layer is formed before the step of forming the pixel electrode by performing an exposure process, a development process, and a baking process to the second protecting layer, such that the surface of the second protecting layer is disposed to be an uneven surface.

11. The display panel of claim 3, wherein the first auxiliary alignment agent molecules and the second auxiliary alignment agent molecules are respectively used for making the liquid crystal molecules be arranged perpendicularly to a surface of the color filter substrate and a surface of the thin film transistor array substrate in the situation that an alignment layer is not used.

12. A display device, comprising:
a backlight module; and
a display panel, the display panel aligned with and assembled to the backlight module, the display panel comprising:
a color filter substrate, the color filter substrate comprising a first protecting layer and a common electrode layer disposed thereon, and the common electrode layer disposed on the first protecting layer;
a thin film transistor array substrate, the thin film transistor array substrate comprising a second protecting layer and a pixel electrode disposed thereon, and the pixel electrode disposed on the second protecting layer, wherein the common electrode layer is disposed corresponding to the pixel electrode; and
a liquid crystal layer comprising:
one or more liquid crystal molecules;
one or more first auxiliary alignment agent molecules, wherein a first end of each of the first auxiliary alignment agent molecules is used for adsorbing to a surface of the common electrode layer, and a second end of each of the first auxiliary alignment agent molecules is used for guiding an arrangement of a corresponding one of the liquid crystal molecules; and
one or more second auxiliary alignment agent molecules, wherein a third end of each of the second auxiliary alignment agent molecules is used for adsorbing to a surface of the pixel electrode and a surface of the second protecting layer, and a fourth end of each of the second auxiliary alignment agent molecules is used for guiding an arrangement of a corresponding one of the liquid crystal molecules,
wherein the color filter substrate is aligned with and assembled to the thin film transistor array substrate, and the liquid crystal layer is disposed between the color filter substrate and the thin film transistor array substrate.

13. The display device of claim 12, wherein the pixel electrode is disposed to be an uneven curved surface, a whole surface of the pixel electrode covers the second protecting layer corresponding to a pixel area, and the pixel electrode is used for applying an electric field to the liquid crystal molecules and used for separating the second auxiliary alignment agent molecules from the second protecting layer.

14. The display device of claim 13, wherein the pixel electrode comprises one or more first concave areas and one or more convex areas;
the pixel electrode is further used for making the second auxiliary alignment agent molecules be adsorbed to surfaces of the first concave areas and surfaces of the first convex areas.

15. The display device of claim 14, wherein an inclined surface is disposed between one of the first concave areas and one of the first convex areas, and the inclined surface connects the one of the first concave areas to the one of the first convex areas;
the pixel electrode is further used for controlling the second auxiliary alignment agent molecules along the inclined surface to be inclined in a predetermined direction.

16. The display device of claim 14, wherein each of the first concave areas of the pixel electrode comprises one or more concave grooves disposed thereon, and each of the first convex areas of the pixel electrode comprises one or more convex ribs disposed thereon;
the convex ribs and the concave grooves are disposed in parallel, at least two of the convex ribs are arranged in an array in a first direction, and at least two of the concave grooves are arranged in an array in the first direction;
one of the concave grooves is disposed between two adjacent convex ribs of the convex ribs, and one of the convex ribs is disposed between two adjacent concave grooves of the concave grooves.

17. The display device of claim 14, wherein the thin film transistor array substrate further comprises a shape forming layer, a surface of the shape forming layer is disposed to be an uneven shape, the pixel electrode is disposed on the shape forming layer, and the shape forming layer is used for forming an uneven degree of the surface of the pixel electrode.

18. The display device of claim 17, wherein the shape forming layer comprises one or more second concave areas and one or more second convex areas, positions of the second concave areas correspond to positions of the first concave areas, and positions of the second convex areas correspond to positions of the first convex areas;
the shape forming layer is formed on the pixel area, and the shape forming layer is disposed between the pixel electrode and the second protecting layer;
the shape forming layer is formed before the step of forming the pixel electrode by coating an organic transparent photoresist on the second protecting layer and then performing an exposure process, a development process, and a baking process to the organic transparent photoresist, such that a surface of the organic transparent photoresist is disposed to be an uneven shape.

19. The display device of claim 17, wherein the second protecting layer serves as the shape forming layer, and the shape forming layer is formed before the step of forming the pixel electrode by performing an exposure process, a development process, and a baking process to the second protecting layer, such that the surface of the second protecting layer is disposed to be an uneven surface.

20. The display device of claim 12, wherein the first auxiliary alignment agent molecules and the second auxiliary alignment agent molecules are respectively used for making the liquid crystal molecules be arranged perpendicularly to a surface of the color filter substrate and a surface of the thin film transistor array substrate in the situation that an alignment layer is not used.
